(19) United States
(12) Patent Application Publication
(10) Pub. No.: US 2016/0335862 A1
(43) Pub. Date: Nov. 17, 2016

(54) TACTICAL PERSONAL SURVEILLANCE AND MONITORING SYSTEM

(71) Applicant: Alexander Jaber, Hamburge (DE)

(72) Inventor: Alexander Jaber, Hamburge (DE)

(21) Appl. No.: 15/112,391

(22) PCT Filed: Jan. 20, 2015
(86) PCT No.: PCT/IB2015/000472

§ 371 Date: Jul. 18, 2016

Related U.S. Application Data
(60) Provisional application No. 61/928,763, filed on Jan. 17, 2014.
(60) Provisional application No. 61/928,773, filed on Jan. 17, 2014.

(51) Int. Cl. G08B 13/196; G08B 25/01; G08B 21/12; H04N 7/18; H04W 4/00

(52) U.S. Cl. CPC G08B 13/19621; H04N 7/181; H04W 4/008; G08B 21/12; G08B 25/016

(57) ABSTRACT

A tactical garment incorporates a tactical surveillance and monitoring system. The exemplary system comprising an electronic central communication base module, and a plurality of electronic peripheral surveillance modules operatively connected to the base module. The surveillance modules are adapted for collecting realtime surveillance data, and communicating the surveillance data to the base module. A wireless communications device transmits the surveillance data captured by the surveillance modules to the base module. An electronic storage medium is integrated with the base module for locally storing the surveillance data. A second wireless communications device transmits the surveillance data from the base module to a remote command center terminal.

### TECHNICAL FIELD AND BACKGROUND OF, THE INVENTION

This invention relates broadly and generally to a tactical surveillance and monitoring system and method. In one exemplary application, the present disclosure comprises a personal surveillance system—referred to herein as “PSS”. The exemplary PSS is a wearable surveillance and monitoring tool which provides users a customizable and portable realtime information and data storage center. The unique and advanced system of the present disclosure provides users the ability to gather, analyze, and disseminate information from the field in real time to a remote command center and/or other remote terminal(s).

The present disclosure comprises a customizable portable information system that can be incorporated into almost any garment for individual mobile security. The exemplary PSS was designed as a tool to expand access to information and enable safety, transparency, and reduce incidents of corruption. Navigation and positioning data, a camera and microphone, vitality sensors, and a full range of environmental sensors give the command center complete access to the wearer's environment. As the amount of real-time information pushed to the remote command center increases, the command center is able to more closely monitor the conditions and safety of the wearer and the wearer's environment.

### SUMMARY OF EXEMPLARY EMBODIMENTS

Various exemplary embodiments of the present invention are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

It is also noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

According to one exemplary embodiment, the present disclosure comprises a MOLLE garment incorporating a tactical surveillance and monitoring system. The exemplary system comprises an electronic central communication base module, and a plurality of electronic peripheral surveillance modules operatively connected to the base module. The surveillance modules are adapted for collecting realtime surveillance data, and communicating the surveillance data to the base module. Wireless communication means are provided for transmitting the surveillance data captured by the surveillance modules to the base module. An electronic storage medium is integrated with the base module for locally storing the surveillance data. Wireless communication means are provided for transmitting the surveillance data from the base module to a remote command center terminal.

The term “tactical” refers broadly and generally herein to any system, assembly, component, or device used either alone or in combination with other systems, assemblies, components, or devices for surveillance.

The term “surveillance” refers broadly and generally herein to any observing, analyzing, monitoring, communicating, or maintaining supervision.

The term “command center” or “remote command center” refers broadly and generally herein to any distant or remote terminal (e.g, computer workstation) separate from the hardware components of the PSS.

The exemplary PSS may be carried, handled or incorporated in any style garment, and may utilize the MOLLE attachment method or any derivatives (such as the Tactical Tailor MALICE clip system) based on such method. Examples of modes of attachment using MOLLE technology include the “Natick Snap”, which uses a polyethlyene reinforced webbing strap with a push-the-dot snap for security; a polymer “Malice” clip which interweaves like the Natick Snap but terminates in a semi-permanent closure that requires a screwdriver or other flat-tipped object to disengage; and a variety of other attachments that fall into the “Weave & Tuck” category, in which the end of an interwoven strap is tucked into an item's backing after attachment to a vest or pack.

According to another exemplary embodiment, the central communication base module comprises a multi-axis sensor for measuring at least one of movement direction and acceleration.

According to another exemplary embodiment, the multi-axis sensor comprises an accelerometer.

According to another exemplary embodiment, the central communication base module further comprises a digital display.

According to another exemplary embodiment, the digital display comprises an OLED display.

According to another exemplary embodiment, the central communication base module further comprises a panic button adapted to wirelessly transmit an alert to the remote command center terminal.

According to another exemplary embodiment, the means for transmitting surveillance data from the surveillance modules to the base module comprises at least one wireless communications card.

According to another exemplary embodiment, the wireless communications card comprises at least one of Bluetooth and Near Field Communication technology.

According to another exemplary embodiment, the means for transmitting surveillance data from the base module to the remote command center terminal comprises a wireless communications modem.

According to another exemplary embodiment, the wireless communications modem comprises WIFI wireless technology.

According to another exemplary embodiment, the means for transmitting surveillance data from the base module to the remote command center terminal comprises a wireless communications modem utilizing a mobile data communications service.

According to another exemplary embodiment, the wireless communications modem utilizes GSM communications protocol.

According to another exemplary embodiment, the peripheral surveillance module comprises a camera module.

According to another exemplary embodiment, the peripheral surveillance module comprises a vitality module.

According to another exemplary embodiment, the vitality module incorporates at least one of a body temperature sensor, heart rate sensor, and perspiration sensor.

According to another exemplary embodiment, the peripheral surveillance module comprises an environment module.

According to another exemplary embodiment, the environment module incorporates at least one of a humidity sensor, temperature sensor, and atmospheric pressure sensor.

According to another exemplary embodiment, the peripheral surveillance module comprises a hazardous surroundings module.

According to another exemplary embodiment, the hazardous surroundings module incorporates a gas detection sensor.

According to another exemplary embodiment, the hazardous surroundings module further incorporates a radiation detection sensor.

### BRIEF DESCRIPTION OF THE DRAWINGS

Exemplary embodiments of the present invention will hereinafter be described in conjunction with the following drawing figures, wherein like numerals denote like elements, and wherein:

FIG. 1 illustrates an exemplary MOLLE vest incorporating a personal tactical surveillance and monitoring system (PSS) according to one embodiment of the present disclosure;

FIG. 2 is a block diagram representing various hardware components of the exemplary PSS central communication base module (CCBM);

FIG. 3 is a block diagram representing certain peripheral modules interconnected to the CCBM, and illustrating two-way wireless communication between the exemplary modules and CCBM, and remotely via WIFI and GSM/GPRS between the CCBM and command base;

FIG. 4 is a board diagram of the exemplary Camera Module sensor;

FIG. 5 is a board diagram of the exemplary Vitality Module sensors;

FIG. 6 is a board diagram of the exemplary Environmental Module sensors;

FIG. 7 is a board diagram of the exemplary Hazardous Environment Module sensors;

FIG. 8 is flow diagram illustrating data communication (message handling) from and between various components of the CCBM;

FIG. 9 is a second flow diagram illustrating data communication (message handling) from and between various components of the CCBM;

FIG. 10 is a flow diagram representing operation, features, and communication of GSM and GPS components of the CCBM;

FIG. 11 is a flow diagram illustrating local time configuration for the exemplary PSS;

FIG. 12 is a flow diagram representing operation of the PSS panic button, and its on and off states; and

FIG. 13 is a further detailed flow diagram illustrating operation of the PSS panic button.

### DESCRIPTION OF EXEMPLARY EMBODIMENTS AND BEST MODE

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

1.0 Overview

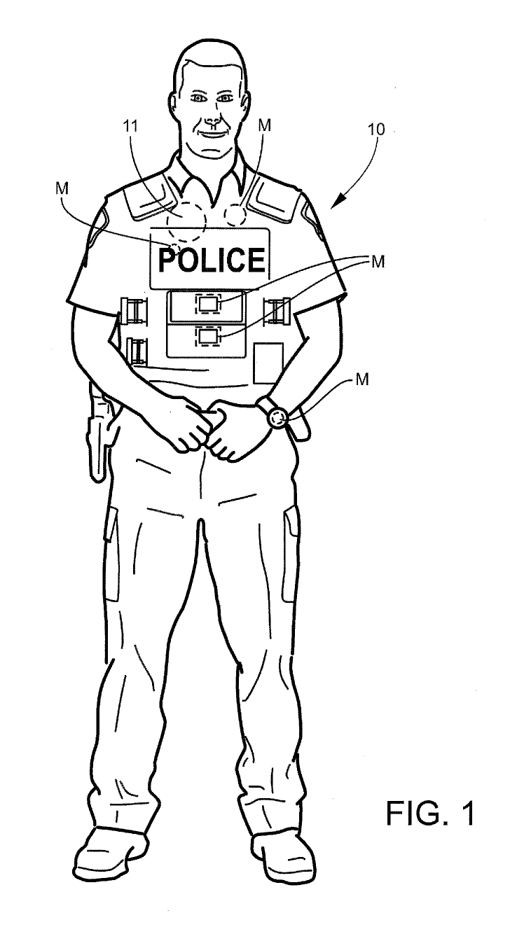

Referring now specifically to the drawings, FIG. 1 illustrates an exemplary MOLLE vest 10 incorporating a personal tactical surveillance and monitoring system (or “PSS”) according to one embodiment of the present disclosure. The exemplary PSS comprises a customized surveillance and monitoring tool which incorporates any number of different electronic modules designed to gather, analyze and store information from the field, and to disseminate this information in realtime to a remote command center. The PSS comprises a lightweight and rugged central communication base module (CCBM) 11 serving as the foundation of the system. Additional user-selected peripheral modules “M” are wirelessly integrated into the PSS via NFC and Bluetooth technology to provide advanced environmental awareness, environmental readings, and two way data communication. Information can be both stored both locally and communicated to a remote terminal (e.g., command center) over WIFI or mobile data. Local storage enables the PSS to continue gathering and saving information in the event one or more modules “M” go offline.

The CCBM 11 and other peripheral modules “M” of the PSS are lightweight, rugged, and compact, and designed for convenient carrying in MOLLE-compatible pouches, utility belts, and other tactical gear. As discussed further below, exemplary features of the PSS include a base video display, camera and microphone, vitality sensors, accelerometer, toxic gas and natural gas sensors, pressure sensors, radiation detector, active and/or passive radio frequency identification (RFID) tags, positioning information, and panic button. The system components use NFC and Bluetooth technology for two-way communication with each other and the CCBM, and WIFI for two-way communication between the CCBM and remote command center.

2.0 Central Communication Base Module (CCBM) 11

The CCBM 11 features a protective IP67 housing and visual display. This base module functions as a central hub by integrating network, location, communication, display and sensor modules. The exemplary CCBM 11 has a panic alert button which automatically immediately sends vital information to the remote command center, and features a cancellation window to minimize false alarms or accidental triggers. The visual display expands the wearer's communication capabilities, and provides system status information with features such as basic two-way messaging and sensor and battery indicators. An accelerometer detects changes in the wearer's orientation or directional heading, pace, sudden changes in movement, free falls, intense vibrations or shocks. The CCBM 11 also features an extensive communication package which incorporates both outdoor GPS and indoor IPS location tracking systems, and uses Bluetooth standards and near field communication (NFC) technology for convenient and reliable pairing of peripheral modules “M” and sensors.

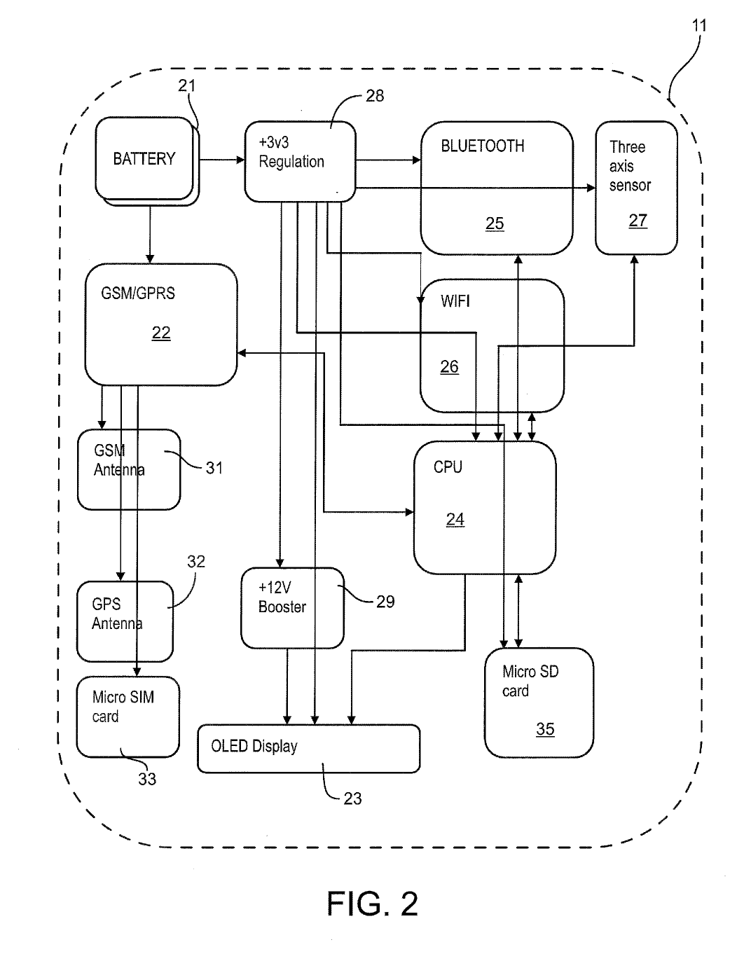

Exemplary hardware components of the CCBM 11 are represented in the diagram of FIG. 2. The CCBM features a battery 21, GSM/GPRS modem 22, OLED display 23, CPU 24, Bluetooth and WIFI cards 25, 26, and three-axis sensor 27. The battery operatively connects to internal regulation and booster components 28, 29, and serves to supply power to all electronics of the CCBM 11. The exemplary battery 21 comprises a 3.7V lithium ion polymer battery (2400 mAh or higher), such as that designed by SAMSUNG for mobile applications. The GSM/GPRS component 22 enables wireless two-way communication for sending and receiving data, and operatively connects to GSM and GPS antennas 31, 32. The GSM/GPRS 22 may also feature a Micro SIM card 33 for data storage, and an audio 3.5 mm jack (not shown) for earphones and audio communication.

The OLED display 23 comprises a single-chip driver, such as SSD1326, with controller for 16 gray scale levels. The OLED driver communicates with the CPU 24 via I2C protocol. The exemplary CPU 24 comprises a 32-bit microcontroller (PIC32MX795F512L) featuring 128 Kb RAM, 80 MHz, 100 pin, and 512 Kb FLASH. The exemplary PCB design comprises a two layer board, 35 micron copper thickness on both sides, black lack, 0.2 mm minimum copper width traces, and 1.55 mm board thickness.

PSS components communicate with the CPU 24 wirelessly via microchip RN 42 Bluetooth card (or ANT+technology) and WIFI card 25, 26. The Bluetooth card 25 uses UART protocol at a speed of 1+Mb/s. The exemplary WIFI card 26 comprises MRF24WG0MA microchip technology, and features an SPI interface, up to 40 Mb/s, with sufficient speed for streaming compressed audio video information and sensor information. A 64 GB (or higher) MicroSD card 35 may connect to the CPU 24 using SPI serial protocol to store PSS data.

The three-axis sensor 27 (e.g., MMA8452QT) communicates with the CPU 24 and functions to measure movement direction and acceleration. The exemplary sensor comprises a low-power, digital output 3-axis linear accelerometer with a I2C interface and embedded logic used to detect events and notify an external microprocessor over interrupt lines. Sensor functionality includes: 8-bit or 12-bit data which includes High-Pass Filtered data, 4 different over-sampling options for compromising between resolution and current consumption based on application requirements, additional low-noise mode that functions independently of the oversampling modes for higher resolution, Low Power and Auto-WAKE/SLEEP modes for conservation of current consumption, Single-/Double-pulse with directional information 1 channel, Motion detection with directional information or Freefall 1 channel, Transient detection based on a high-pass filter and settable threshold for detecting the change in acceleration above a threshold with directional information 1 channel, Portrait/Landscape detection with trip points fixed at 30° and 60° for smooth transitions between orientations.

In addition to the CCBM 11, the exemplary PSS may comprise other electronic modules including (but not limited to) a Camera Module 40, Vitality Module 50, Environmental Module 60, Hazardous Environment Module 70, and Thermal Imaging Modules (not shown). Each of these peripheral modules 40, 50, 60, 70 is discussed separately below.

3.0 Camera Module 40

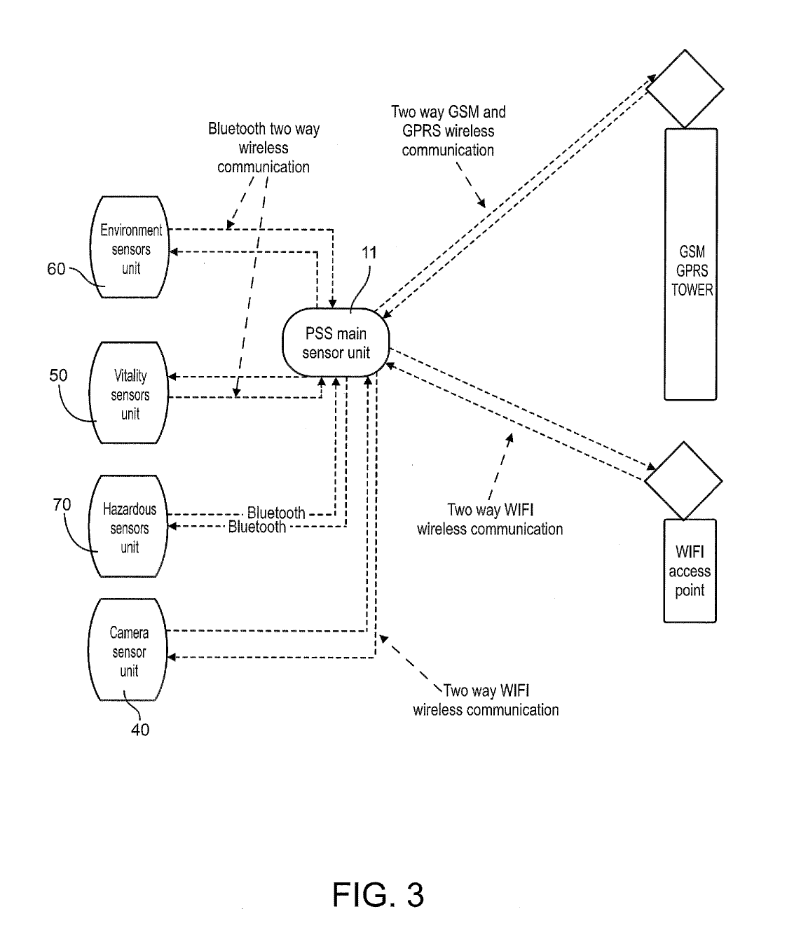

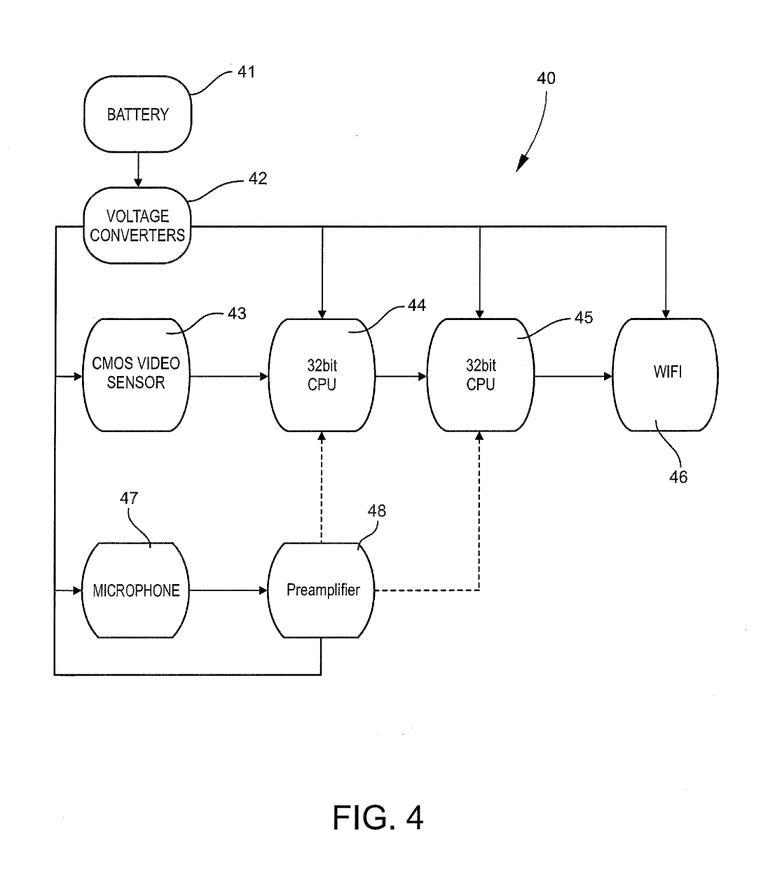

Referring to FIGS. 3 and 4, the exemplary Camera Module 40 is wirelessly connected to the CCBM 11, and comprises a small camera and microphone unit that can be clipped or affixed onto the wearer's MOLLE garment to provide eyes and ears to the remote command center (terminal). This module can offer full 1080 p HD at 30 fps and 16× digital zoom. The Camera Module communicates with the CCBM via Bluetooth, has a built-in microphone to relay sound to the remote command center, and has both day and night mode capabilities. The Camera Module may also feature an Omnivision CMOS sensor for video and photograph recording, CMOS sensor for video stream, compass sensor, and two-way WIFI stream to the CCBM and command center and/or other remote terminal(s).

Camera Module hardware is represented in FIG. 4. The hardware shown includes a battery 41, voltage converters 42, CMOS video sensor 43, a first CPU 44, a second CPU 45, WIFI card 46, microphone 47, and preamplifier 48. The exemplary battery comprises a 3.7V, 3000 mAh, lithium ion polymer battery. The CMOS video sensor comprises an Omnivision OVM7690—capture VGA sensor with 7-bit digital output. The first CPU comprises a 32 BIT CPU (PI32MX795F512) including CMOS sensor capture with 2 DMA channels. The second CPU comprises a 32 BIT CPU (PIC32MZ or ARM9) featuring h.264/h.265 encoder with 2 DMA channels and WiFi communication. The WIFI card comprises a MRF24WG0MA microchip WIFI module with SPI. The microphone is an ultra-compact, low-power, omnidirectional, digital MEMS microphone (MP34DT01) built with a capacitive-sensing element and an IC interface.

Alternatively, or in addition, the exemplary PSS may comprise an ultra-low-power intelligent audio and video, LX5x series WIFI camera module. This module is a fully compliant with IEEE802.11b/g/n wireless protocol. The exemplary module integrates audio-video image capturing, compression coding, and transmission. The module is an efficient hard-coded, strong WIFI communicating module, ensuring clarity and fluency of video, as well as precise audio and video playback and display by any intelligent terminal such as Android, iPhone, PC and other devices. It provides several function expansion interfaces, such as GPIO, PWM, ADC, SDIO, USB, UART, and others.

4.0 Vitality Module 50

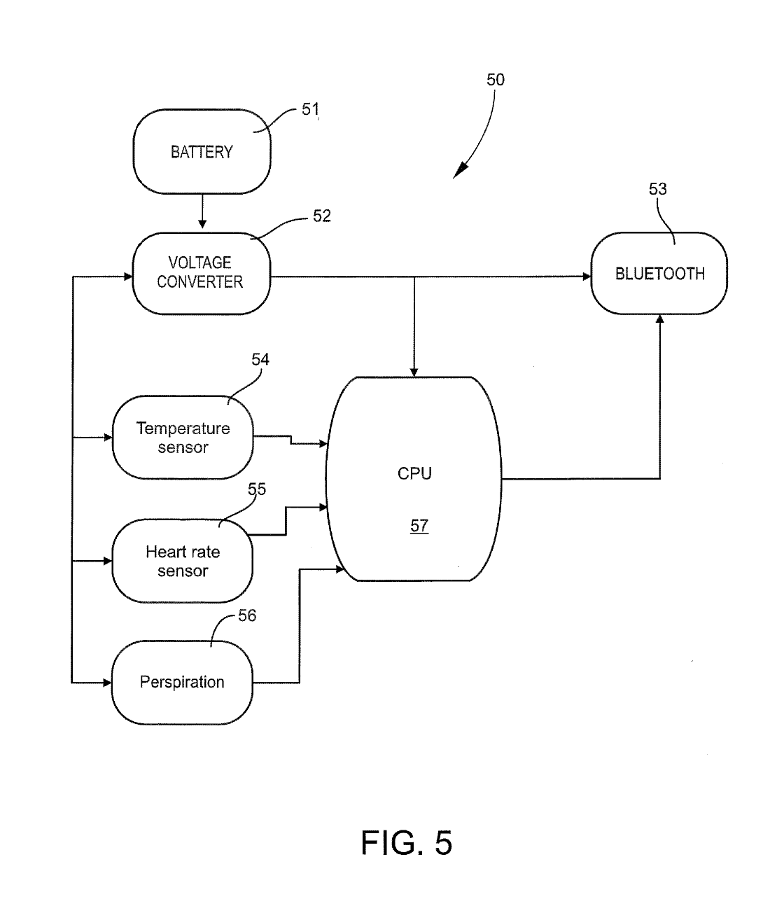

Referring to FIGS. 3 and 5, the Vitality Module 50 is wirelessly connected to the CCBM 11, and provides an added layer of protection to the wearer by enabling the remote command center to closely monitor the wearer's health and physical safety in realtime. The sensors may be incorporated into a discrete and compact wrist unit with adjustable notification options. The Vitality Module can alert the command center when the wearer's heart rate becomes dangerously elevated or stops, monitor the wearer's hydration levels, and even monitor whether the wearer may have fallen asleep on the job or in the field.

The wearable sensors can provide electrocardiogram, pulse, body temperature, and perspiration level measurements that are transmitted via Bluetooth to the CCBM and wirelessly on to the remote command center. By monitoring the wearer's vitals, the command center can help protect the health of the wearer and quickly send help should any of the measures drop to dangerous levels.

Vitality Module hardware is represented in FIG. 5. The hardware shown includes a battery 51 connected to voltage converter 52, Bluetooth card/module 53, temperature sensor 54, heart rate sensor 55, perspiration sensor 56, and CPU 57. The exemplary battery comprises a 3.7V, 300 mAh, lithium ion polymer battery (cell model PCF582124). The exemplary temperature sensor comprises a precision integrated-circuit temperature sensor (LM60/LM60-Q1) that can sense a −40° C. to +125° C. temperature range, while operating from a single +2.7V supply. The exemplary Bluetooth card comprises a microchip RN 42 module (or ANT+technology) which uses UART communication protocol at a speed of 1+Mb/s. The CPU may comprise a 32-bit CPU, such as that previously described.

5.0 Environmental Module 60

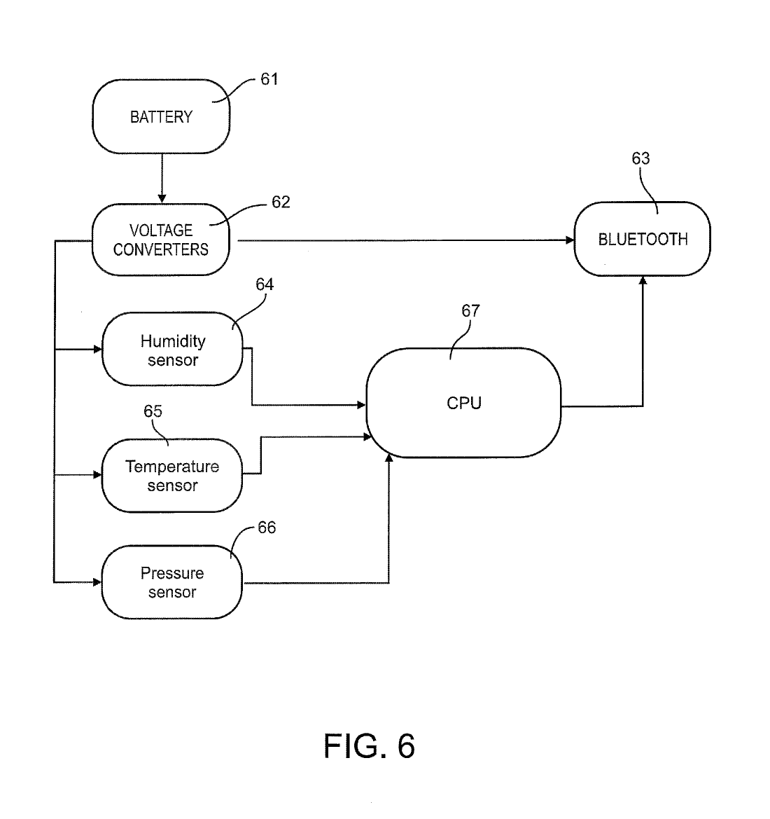

Referring to FIGS. 3 and 6, the Environmental Module 60 is likewise wirelessly connected to the CCBM 11, and enables both the wearer and the command center to closely monitor realtime environmental (field) conditions. Using this module, the wearer can proceed with a higher degree of safety and confidence knowing his surroundings are safe. Additionally, the command center can alert nearby personnel when unsafe levels are detected, quickly removing them from danger.

An air quality sensor provides continuous readings on often-undetectable dangers such as carbon monoxide and oxygen levels. A temperature sensor included in the module records ambient temperature, and a pressure sensor measures atmospheric pressure. The environmental sensors can detect sudden weather changes and air pressure changes that result from blasts and explosions. All readings by the environmental sensors are transmitted to the CCBM via Bluetooth (or ANT+wireless device) and on to the remote command center via WIFI when the sensors detect unsafe levels.

Environment Module hardware is represented in FIG. 6. The hardware shown includes a battery 61 connected to voltage converters 62, Bluetooth card/module 63, humidity sensor 64, temperature sensor 65, pressure sensor 66, and CPU 67. The exemplary battery comprises a 3.7V, 300 mAh, lithium ion polymer battery (cell model PCF582124). The exemplary humidity sensor comprises a HIH 4030/4031 series integrated circuit humidity sensor by Honeywell. The exemplary temperature sensor comprises a precision integrated-circuit temperature sensor (LM60/LM60-Q1) that can sense a −40° C. to +125° C. temperature range, while operating from a single +2.7V supply. The exemplary pressure sensor is designed to sense absolute air pressure in altimeter or barometer (BAP) applications. Freescale's BAP sensor integrates on-chip, bipolar op amp circuitry and thin film resistor networks to provide a high level analog output signal and temperature compensation. As previously described, the exemplary Bluetooth card may comprise a microchip RN 42 module (or ANT+technology) which uses UART communication protocol at a speed of 1+Mb/s. The CPU may comprise a 32-bit CPU.

6.0 Hazardous Environment (Surroundings) Module 70

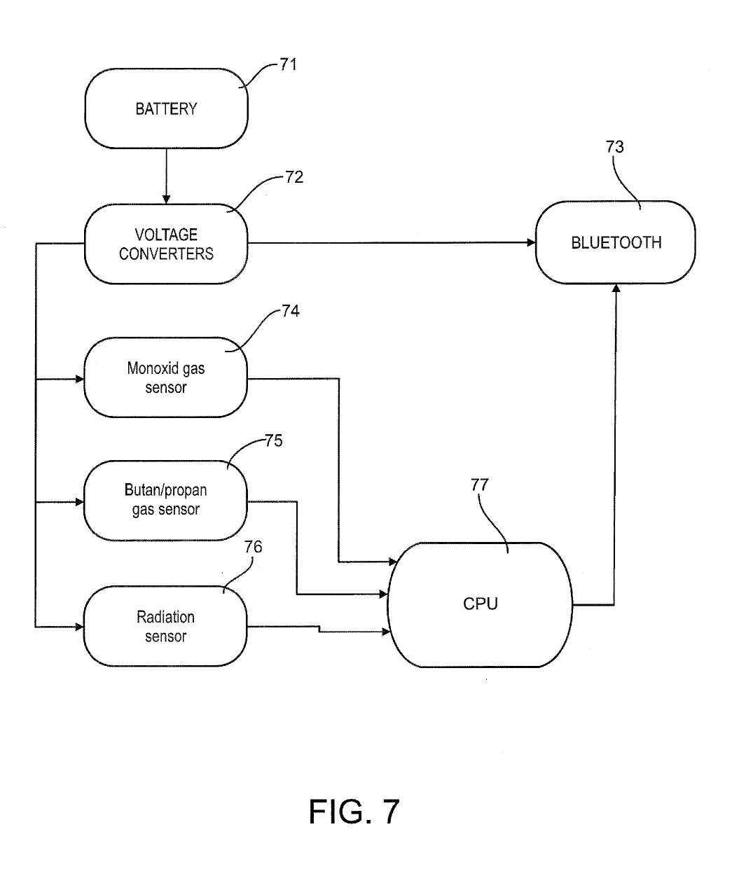

Referring to FIGS. 3 and 7, the exemplary PSS may also provide tools for detecting hazardous environmental materials, many of which are often undetectable by humans. The Hazardous Environment Module 70 is wirelessly connected to the CCBM 11, and equips the wearer with the gas sensors that will alert the wearer and the command center to the presence of propane, butane, methane, and natural gas readings at unsafe levels.

The exemplary module may also incorporate a radiation sensor to monitor radiation levels in areas of known exposure, as well as in a precautionary capacity to alert the guard and the command center to the presence of harmful radiation levels. The potential for harmful radiation exposure is a devastating byproduct of damage to nuclear energy facilities and uncertain radiation distribution channels from known areas of concentration.

The combined capabilities of the Hazardous Environment Module 70 can also be a valuable tool for first responders and medical personnel engaged in disaster relief by removing uncertainty as to the safety of their environment and allowing them to focus on providing aid to others. All module readings are communicated via Bluetooth (or ANT+technology) to the CCBM 11 for local storage and wirelessly from the CCBM 11 via WIFI to the remote command center.

Hazardous Environment Module hardware is represented in FIG. 7. The hardware shown includes a battery 71 connected to voltage converters 72, Bluetooth card/module 73, monoxide gas sensor 74, butane/propane gas sensor 75, radiation sensor 76, and CPU 77. The exemplary battery comprises a 3.7V, 300 mAh, lithium ion polymer battery (cell model PCF582124). The monoxide gas sensor may comprise an MQ-7 sensor, while the butane/propane sensor may comprise an MQ-6 gas sensor. The radiation sensor (e.g., RD2014) is based on an array of customized PIN diodes, and comprises an integrated pulse discriminator with a temperature compensated threshold level. The RD2014 sensor is capable of detecting beta radiation (electrons), gamma radiation (photons) and X-rays. The exemplary Bluetooth card may comprise a microchip RN 42 module (or ANT+technology) which uses UART communication protocol at a speed of 1+Mb/s. The CPU may comprise a 32-bit CPU.

In addition to the above, the exemplary PSS may incorporate other handheld peripheral modules (not shown), such as an optional handheld thermal imager camera (TIC). The TIC takes readings of infrared radiation and produces a visible light display on the CCBM or directly to the remote command center. With a handheld TIC, images can be detected through smoke, heat-permeable barriers, and in darkness. Heat signatures can also be used to identify animals, people and objects. The added benefits of a TIC span applications such as faulty electrical connections, detecting wildlife, aiding first responder and rescue operations to locate trapped victims and pets, and can be used as a stealth detection tool in surveillance.

7.0 Power Supply

The exemplary PSS features an interchangeable battery design for cross-compatibility with the wirelessly connected modules. For the modules that naturally draw more power, the batteries are removable to facilitate on-the-go battery exchanging. The batteries are compact and lightweight so as to allow the user to carry extras, as needed. All external batteries are exchangeable and rechargeable, and have an average battery life of 10 hours on a full charge. For more compact modules that have smaller power requirements, the batteries feature a fixed internal mount. Internal batteries are rechargeable and have an average battery life of 16 hours, depending on specific usage.

All batteries used in the PSS are rechargeable via an external battery charger with a single charging bay, or a multi-charging bay that can charge up to 5 batteries simultaneously. A single-bay vehicle charger may be used for charging on-the-go. PSS Modules with internal mount batteries may be charged wirelessly. For renewable energy recharging, single pack solar and kinetic chargers may also be used. Battery health and charging status can be monitored through each of the charging units.

8.0 PSS Message Handling

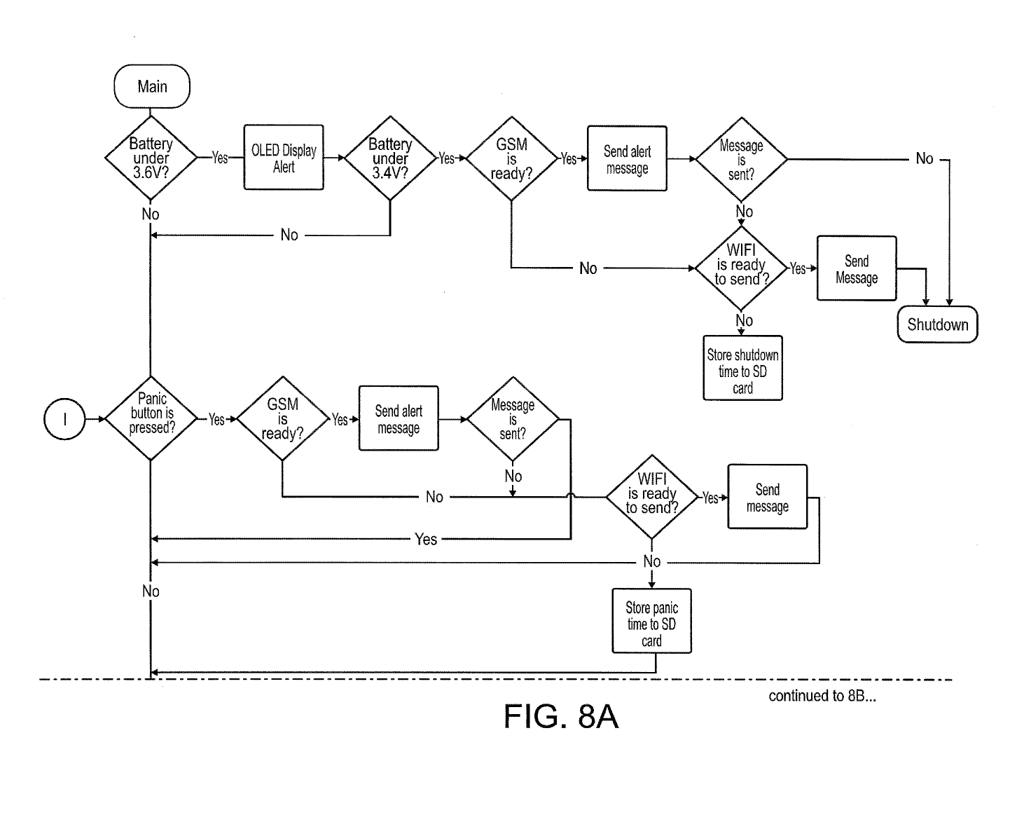

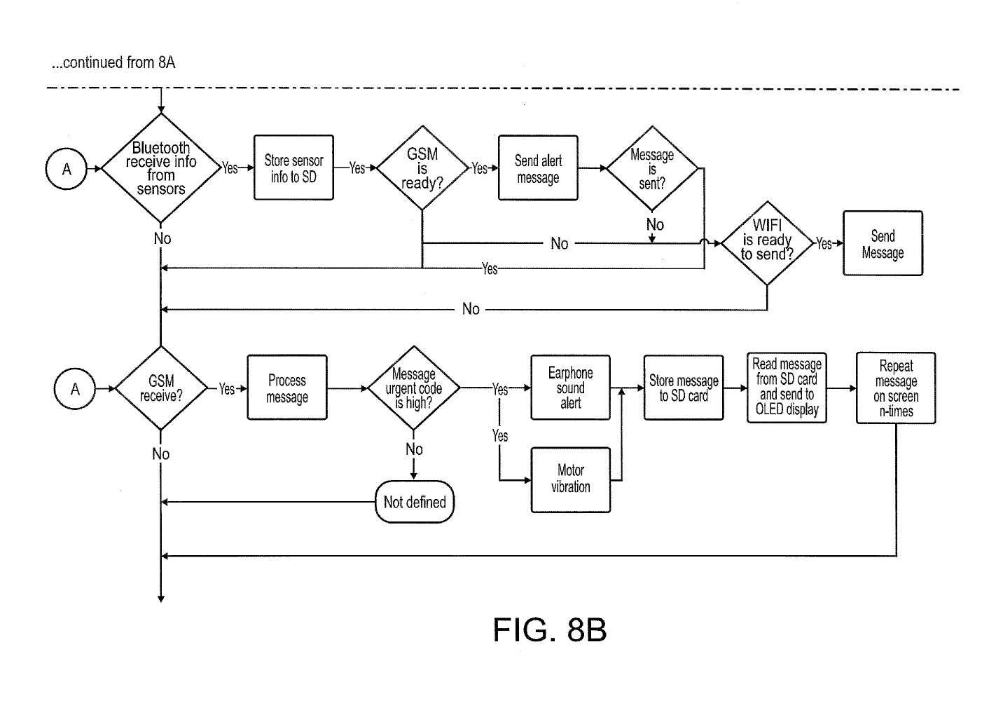

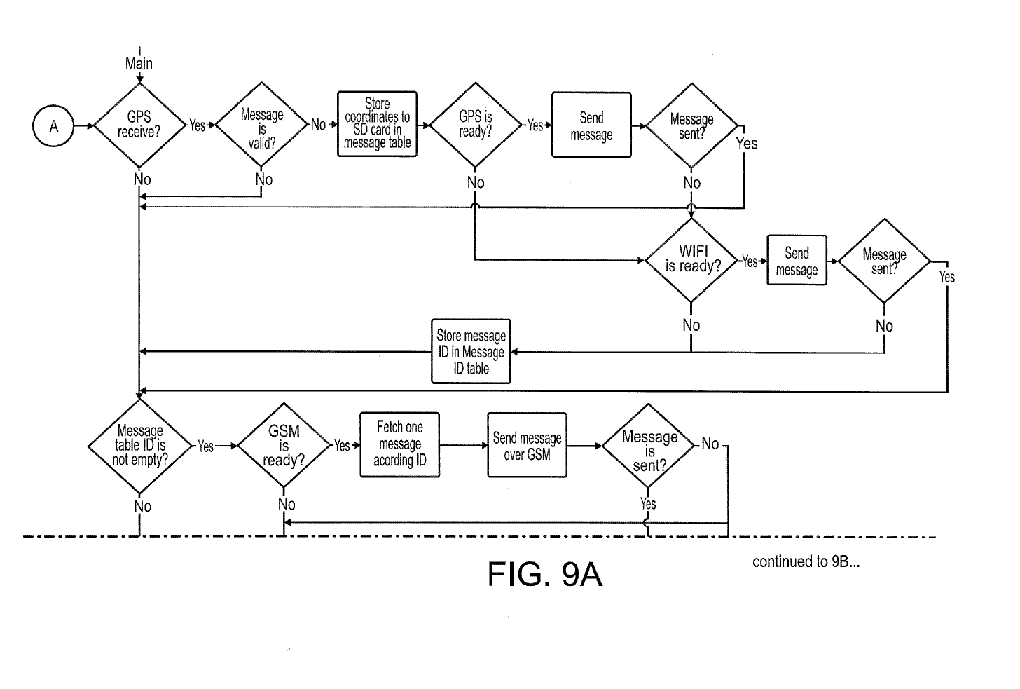

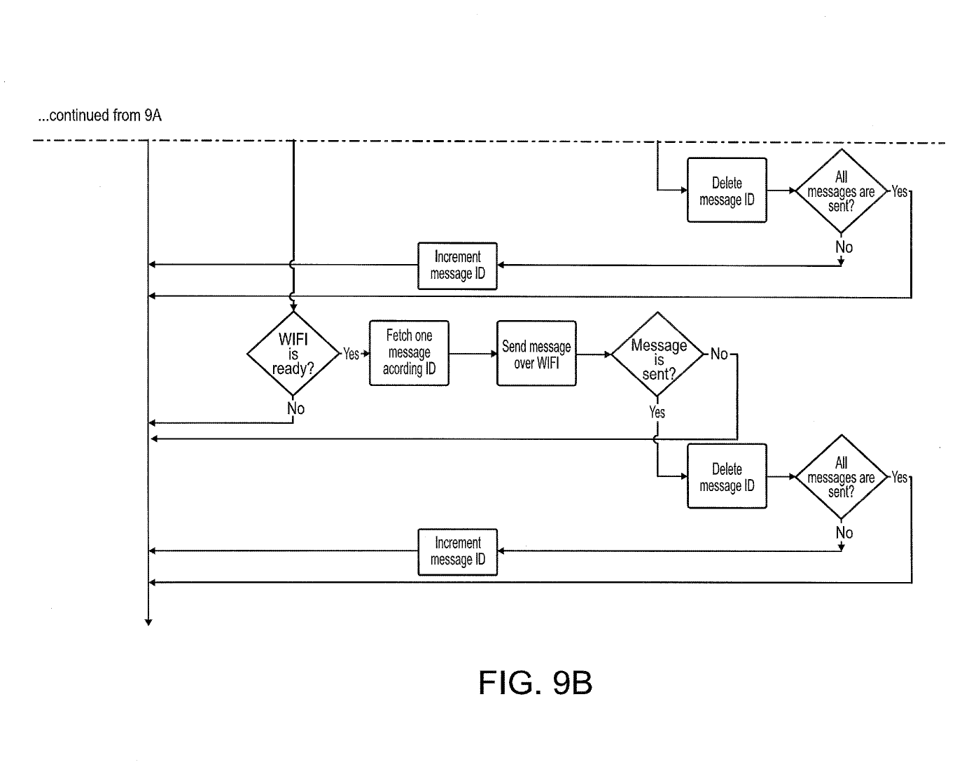

FIGS. 8 and 9 demonstrate exemplary processes for handling the communication of messages between the CCBM, wirelessly connected peripheral modules, and remote command center (terminal).

I—external manual interrupt source

A—external automatic interrupt source

9.0 GSM and GPS Communication

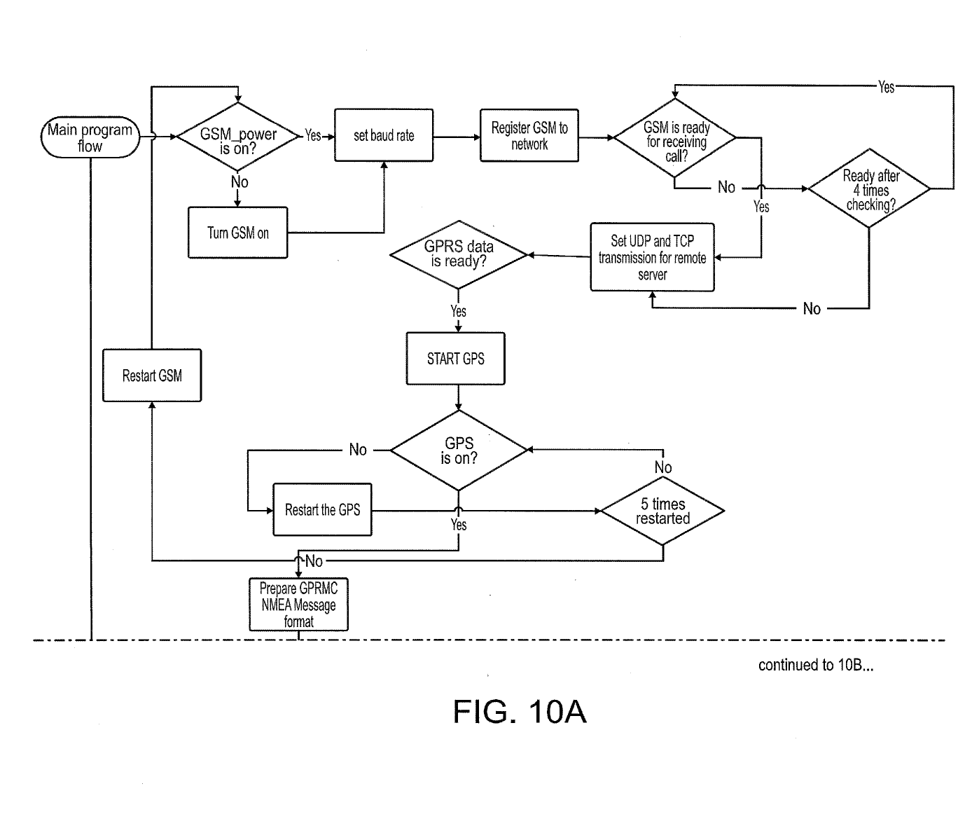

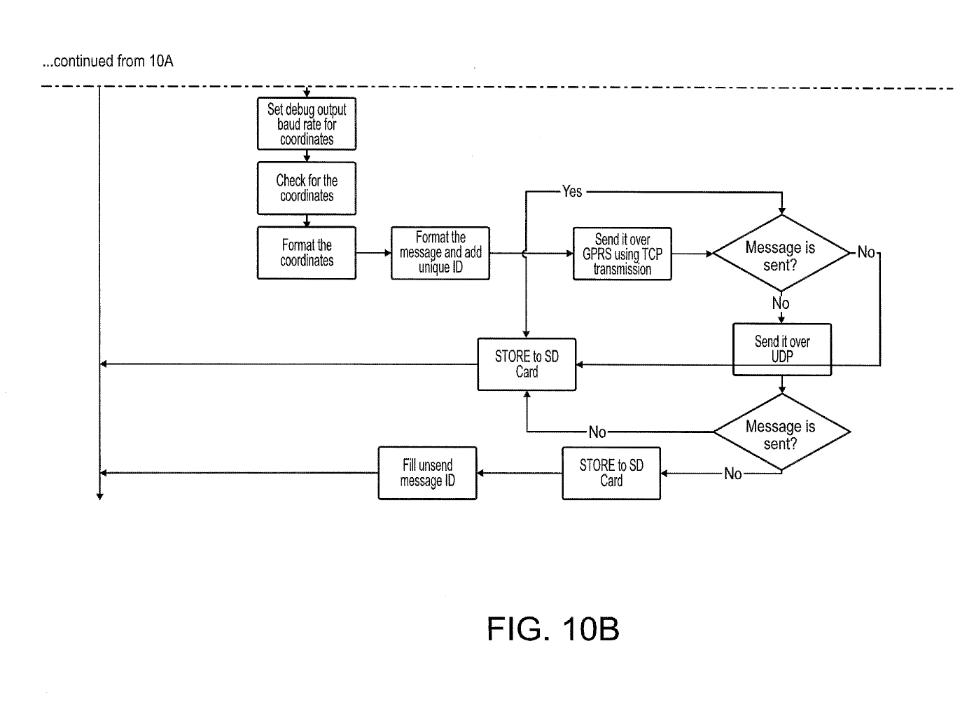

FIG. 10 demonstrates process flow for GSM and GPS communication in the exemplary PSS.

10.0 Real Time Clock

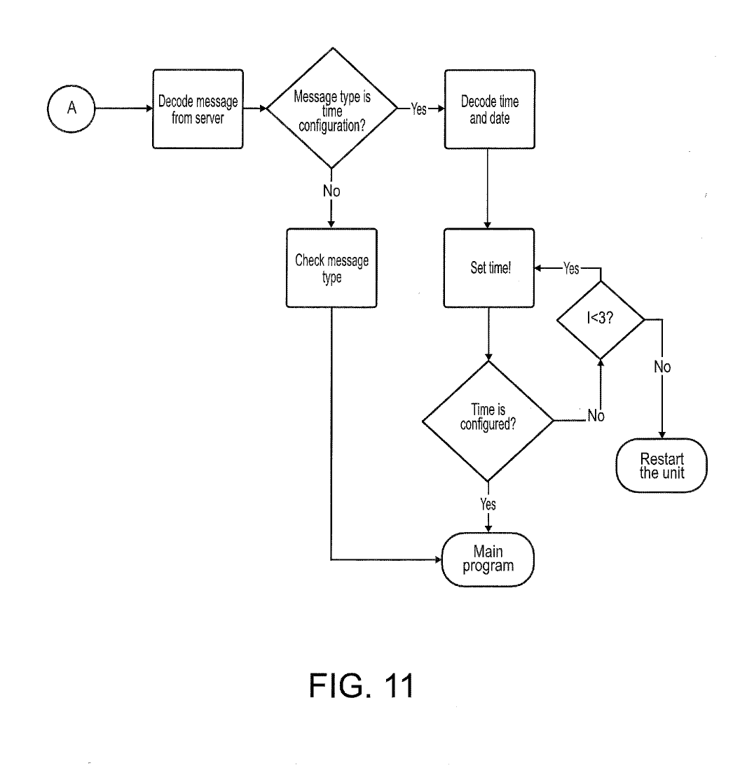

PSS CCBM incorporates a real time clock for time-stamping all recorded activity and events, including sensor data transmitted by each of the modules and panic alerts. FIG. 11 demonstrates one exemplary process for PSS local time configuration.

11.0 PSS Panic Button Communication

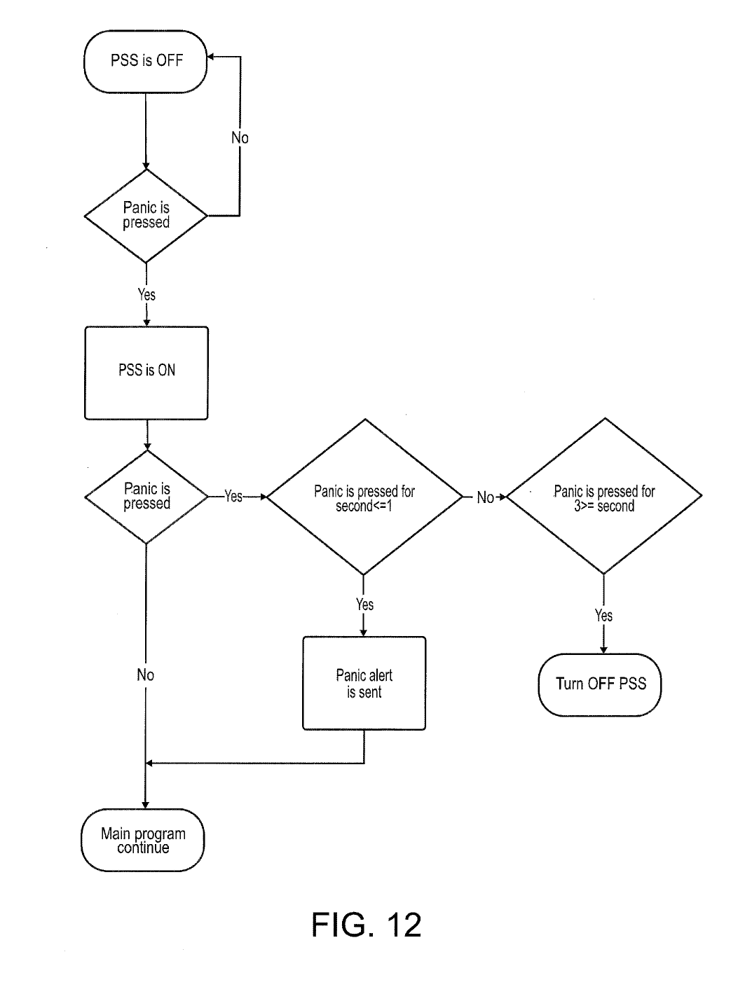

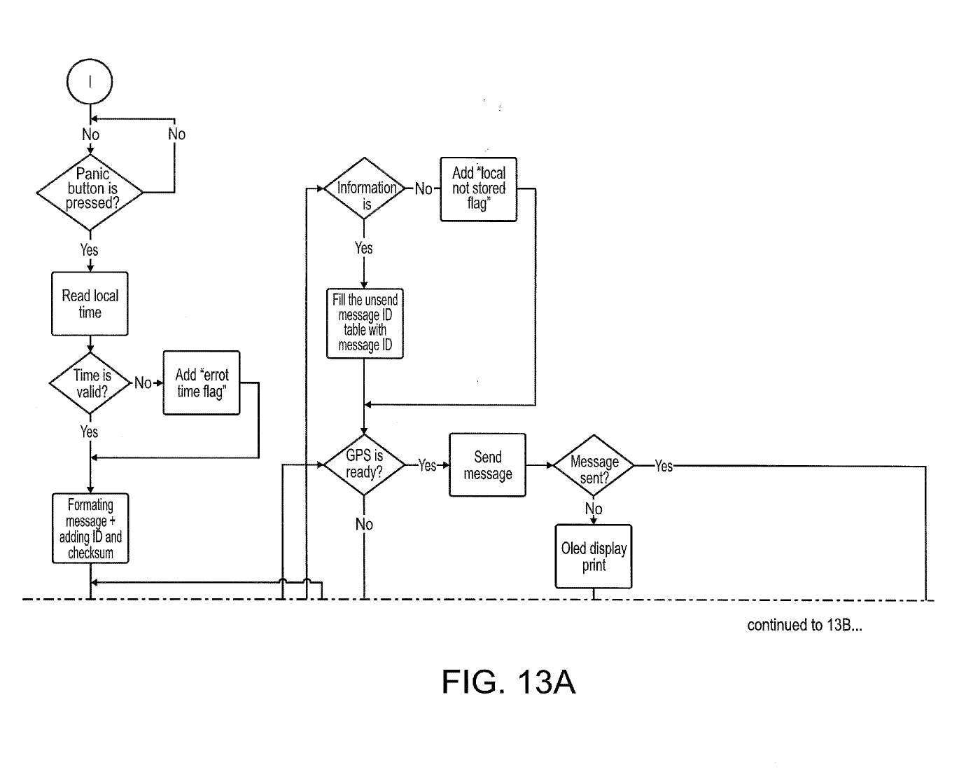

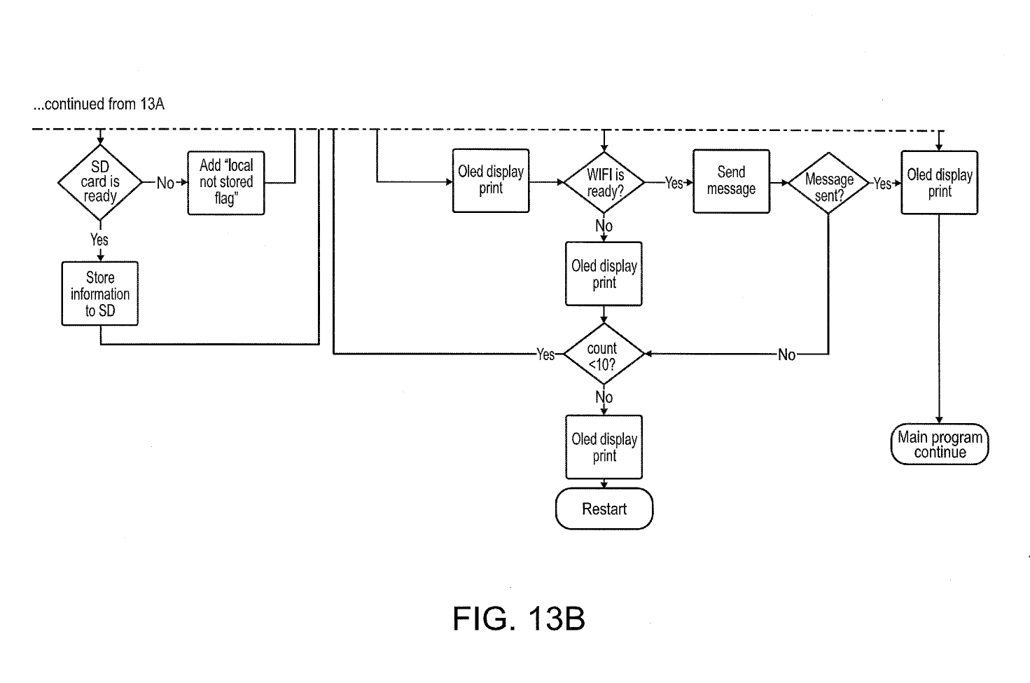

Activation and operation of the panic button in the exemplary PSS, and resulting message communication is demonstrated in the flow diagrams of FIGS. 12 and 13.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under §112, 6th paragraph is not intended. Additionally, it is not intended that the scope of patent protection afforded the present invention be defined by reading into any claim a limitation found herein that does not explicitly appear in the claim itself.

What is claimed:

1. A tactical garment incorporating a tactical surveillance and monitoring system, comprising:
an electronic central communication base module;
a plurality of electronic peripheral surveillance modules operatively connected to said base module, and adapted for collecting realtime surveillance data and communicating the surveillance data to said base module;
means for transmitting the surveillance data captured by said surveillance modules to said base module;
an electronic storage medium integrated with said base module for locally storing the surveillance data; and
means for transmitting the surveillance data from said base module to a remote command center terminal.

2. The tactical garment according to claim 1, wherein said central communication base module comprises a multi-axis sensor for measuring at least one of movement direction and acceleration.

3. The tactical garment according to claim 2, wherein said multi-axis sensor comprises an accelerometer.

4. The tactical garment according to claim 1, wherein said central communication base module further comprises a digital display.

5. The tactical garment according to claim 4, wherein said digital display comprises an OLED display.

6. The tactical garment according to claim 1, wherein said central communication base module further comprises a panic button adapted to wirelessly transmit an alert to the remote command center terminal.

7. The tactical garment according to claim 1, wherein said means for transmitting surveillance data from said surveillance modules to said base module comprises at least one wireless communications card.

8. The tactical garment according to claim 7, wherein said wireless communications card comprises at least one of Bluetooth and Near Field Communication technology.

9. The tactical garment according to claim 1, wherein said means for transmitting surveillance data from said base module to the remote command center terminal comprises a wireless communications modem.

10. The tactical garment according to claim 9, wherein said modem comprises WIFI wireless technology.

11. The tactical garment according to claim 1, wherein said means for transmitting surveillance data from said base module to the remote command center terminal comprises a wireless communications modem utilizing a mobile data communications service.

12. The tactical garment according to claim 11, wherein said wireless communications modem utilizes GSM communications protocol.

13. The tactical garment according to claim 1, wherein said peripheral surveillance module comprises a camera module.

14. The tactical garment according to claim 1, wherein said peripheral surveillance module comprises a vitality module.

15. The tactical garment according to claim 14, wherein said vitality module incorporates at least one of a body temperature sensor, heart rate sensor, and perspiration sensor.

16. The tactical garment according to claim 1, wherein said peripheral surveillance module comprises an environment module.

17. The tactical garment according to claim 16, wherein said environment module incorporates at least one of a humidity sensor, temperature sensor, and atmospheric pressure sensor.

18. The tactical garment according to claim 1, wherein said peripheral surveillance module comprises a hazardous surroundings module.

19. The tactical garment according to claim 18, wherein said hazardous surroundings module incorporates a gas detection sensor.

20. The tactical garment according to claim 19, wherein said hazardous surroundings module further incorporates a radiation detection sensor.
